(19) United States
(12) Patent Application Publication
(10) Pub. No.: US 2003/0150678 A1
(43) Pub. Date: Aug. 14, 2003

(54) Damper device that uses viscous fluid and its manufacturing method

(76) Inventor: Hiroyuki Iwashita, Nagano (JP)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/347,998

(22) Filed: Jan. 21, 2003

(30) Foreign Application Priority Data
Jan. 23, 2002 (JP) 2002-014151

(51) Int. Cl. F16D 57/02

(52) U.S. Cl. 188/296; 188/290

(57) ABSTRACT

A damper device that uses viscous fluid comprises a cylindrical member having a cylindrical inner surface, a shaft being arranged inside the cylindrical member to face the inner surface in the radial direction, an outer circumferential surface of the shaft and the inner surface of the cylindrical member forming a space for a viscous fluid to be injected, a partition wall formed at the cylindrical member to project toward the space, wings being provided on the shaft for pressurizing the viscous fluid and check valves associated with the wings. The shaft has a flange portion having a diameter larger than that of a shaft portion of the shaft and also having a first viscous fluid pressure surface for the viscous fluid. The cylindrical member has a second viscous fluid pressure surface for the viscous fluid, a small opening having the same diameter as that of the shaft portion and a large opening having the same diameter as that of the flange portion and a first sealing member provided between the shaft portion and the small opening and a second sealing member provided between the flange portion and the large opening to seal the viscous fluid.

### CROSS-REFERENCE TO RELATED APPLICATIONS

This application claims priority of Japanese application No. 2002-014151, filed Jan. 23, 2002, the complete disclosure of which is hereby incorporated by reference.

### BACKGROUND OF THE INVENTION

The present invention relates to a damper device that uses viscous fluid. More specifically, it relates to a structure and assembling means of a damper used in a revolving damper device, which is applied to revolving lids, revolving doors and the like that open and close with a hinge.

### DESCRIPTION OF THE RELATED ART

FIG. 9 schematically shows a major portion of a conventional damper device 100 that uses viscous fluid: (a) is a horizontal cross-section perpendicular to a rotary shaft C; (b) is a vertical cross-section along the rotary shaft C. A case 105 is fixed to a western-style toilet seat (not illustrated) and a rotor member 101 is attached to a hinge of the seat/cover. When the toilet seat/cover is revolved in the closing direction from a wide-open state (clockwise CW in FIG. 9 (a)), the rotor member 101 revolves together with the hinge of the seat/cover, and then check valves 102 attached to the rotor member 101 are tightly attached to revolving wings 103 provided to the rotor member 101 with resistance of the viscous fluid (oil) (illustrated in left half of FIG. 9 (a)). Therefore, orifices 104 formed in the revolving wings 103 are covered with the check valves 102, reducing the flow of the viscous fluid (oil). With this, the resistance of the viscous fluid (oil) works against gravity, and the toilet seat/cover does not shut abruptly, but closes slowly.

When the toilet seat/cover is revolved from the closed-state in the opening direction (counterclockwise CCW in FIG. 9 (a)), the rotor member 101 is revolved and the check valves 102 are released from the tight attachment with the revolving wings 103 by the resistance of the viscous fluid (oil) (illustrated in right half of FIG. 9 (a)). The orifices 104 are opened wide, and therefore the viscous fluid (oil) flows with an absence of resistance. For this reason, the toilet seat/cover can be opened with a light force, supporting children, the elderly, and the disabled to use it easily.

Problems Addressed by the Invention

However, as understood in FIG. 9 (b), this kind of damper device 100 that uses viscous fluid is configured such that the rotor member 101 having the check valves 102 is first inserted into a case 105 which is composed of a cylindrical member, a viscous fluid (oil) is filled, and then the case 105 is sealed with a cover 106 by screwing or ultrasonic-welding to prevent the viscous fluid (oil) from leaking. For this reason, there are many portions that need to be sealed by O-rings 107 and 108 (three portions in the illustrated example). This may cause the viscous fluid (oil) to leak if there are problems in the components or assembly, and also increases the number of components due to a number of sealing portions.

Even though the case 105 is fixed to the cover 106 by screwing or ultrasonic-welding, the viscous fluid pressure inside the case 105 exerts force in the direction to separate the case 105 from the cover 106. Therefore, the possibility of oil leak still remains. Thus, the fixing method for the case 105 and the cover 106 tends to have problems, possibly causing the viscous fluid (oil) to leak.

Japanese Laid-open Patent Application H10-318319 has disclosed a configuration in which a case with bottom 2 is used to reduce the number of sealing portions. However, this configuration limits its application because the connection with the rotary member 5 is obtained with only one side. In the damper device that uses viscous fluid, which is applied to a toilet seat/cover, check valves are provided and so there are two directions: one in which a damping function is at work; the other in which the damping function is idle. Therefore, two kinds of dampers with a damping function which works in opposite directions need to be prepared for counter-products that need left-right symmetric settings.

Also, Japanese Laid-open Patent Application H7-301272 (Japanese Patent No. 3053156) has disclosed a damper in which first, a casing 1 and a closing lid 5 are fixed to each other by a bolt 62, a viscous fluid is injected through an injection opening 12, and then the injection opening 12 is sealed with a bolt 61. With this configuration, however, when a viscous fluid is injected through the injection opening 12, it takes time to evacuate the air. And a viscous fluid with high viscosity, which is used to improve damper properties, is especially difficult to be injected through a hole due to its high viscosity. Further, a damper to be used for a door closer may have a configuration in which the viscous fluid (oil) is injected through an injection hole first and then a steel ball is used to cover and seal the viscous fluid (oil) injection hole or an air-evacuating hole. Although this configuration may be applied with metallic members, it is not compatible with resin molds which are used for toilet seats/covers.

### OBJECT AND SUMMARY OF THE INVENTION

Then, a primary object of the present invention is to provide a damper device in which while the number of sealing positions of sealing members, which are used to prevent the injected viscous fluid from leaking, is reduced, and the reliability toward the viscous fluid leak prevention is improved.

Another object of the present invention is to provide a manufacturing method of a damper device, in which the viscous fluid can be easily injected, a viscous fluid loss due to overflow is reduced, and an assembling operation can be simply done.

To achieve the above objectives, the present invention provides a damper device that uses viscous fluid, which comprises of a cylindrical member having a cylindrical inner surface, a shaft arranged inside the cylindrical member to face the inner surface in the radial direction, a space created by an outer circumferential surface of the shaft and the inner surface of the cylindrical member for a viscous fluid to be injected, a partition wall formed on the cylindrical member to project toward the space, wings provided on the shaft for pressurizing the viscous fluid, and check valves; wherein the shaft has a flange portion having a diameter larger than that of a shaft portion of the shaft and also has a first viscous fluid pressure surface for the viscous fluid; the cylindrical member has a second viscous fluid pressure surface for the viscous fluid, a small opening having the same diameter as that of the shaft portion, and a large opening having the same diameter as that of the flange portion; a first sealing member is provided between the shaft portion and the small opening and a second sealing member is provided between the flange portion and the large opening to seal the viscous fluid.

Also, O-rings are used for the first and the second sealing members to seal the viscous fluid.

Also, as a method of injecting oil into a space created by the case inner surface and the rotor outer surface, a guide member is fitted in the small opening and a predetermined amount of viscous fluid is injected into the space that is created temporarily by the guide member and the inner surface of the cylindrical member, and then the guide member is replaced with the shaft.

It is suitable that the guide member has the same diameter as that of the shaft portion of the shaft and is capable of entering the small opening, and an engaging portion that can be engaged with the shaft portion is provided at an end portion of the guide member, the shaft portion is engaged with the engaging portion formed at the end portion of the guide member, and then the guide member is replaced with the shaft.

### BRIEF DESCRIPTION OF THE DRAWINGS

In the drawings:

FIGS. 1(a) and 1(b) show a cross-section of a first embodiment of a damper device that uses viscous fluid of the present invention: FIG. 1(a) is a cross-section along a rotary shaft; FIG. 1(b) is a cross-section perpendicular to the rotary shaft;

FIGS. 2(a) and 2(b) show a schematic diagram of an operation of check valves in the damper device that uses viscous fluid illustrated in FIG. 1; FIG. 2(a) shows the function at work; FIG. 2(b) shows the function not at work;

FIGS. 3(a)-(d) are schematic cross-sections showing an assembly of the damper device that uses viscous fluid of the present invention;

FIG. 4 is a perspective diagram of FIG. 3 (c);

FIG. 5 is a schematic axial cross-section of a second embodiment of the damper device that uses viscous fluid of the present invention;

FIG. 6 is a schematic axial cross-section of a third embodiment of the damper device that uses viscous fluid of the present invention;

FIG. 7 is a schematic axial cross-section of a fourth embodiment of the damper device that uses viscous fluid of the present invention;

FIG. 8 is a schematic axial cross-section of a fifth embodiment of the damper device that uses viscous fluid of the present invention; and

FIG. 9 is a schematic operational diagram of a conventional damper device that uses viscous fluid.

### DESCRIPTION OF THE PREFERRED EMBODIMENTS

Embodiments of a damper device that uses viscous fluid of the present invention will be described hereinafter based on the drawing. Normally oil or grease is used as the viscous fluid, and the embodiments are described with a damper device that uses oil (hereinafter denoted as “oil damper device”). A viscous fluid with high viscosity is used in the embodiments. Note that grease may be substituted for oil and the viscous fluid is not limited to the one having high viscosity (such as oil/grease).

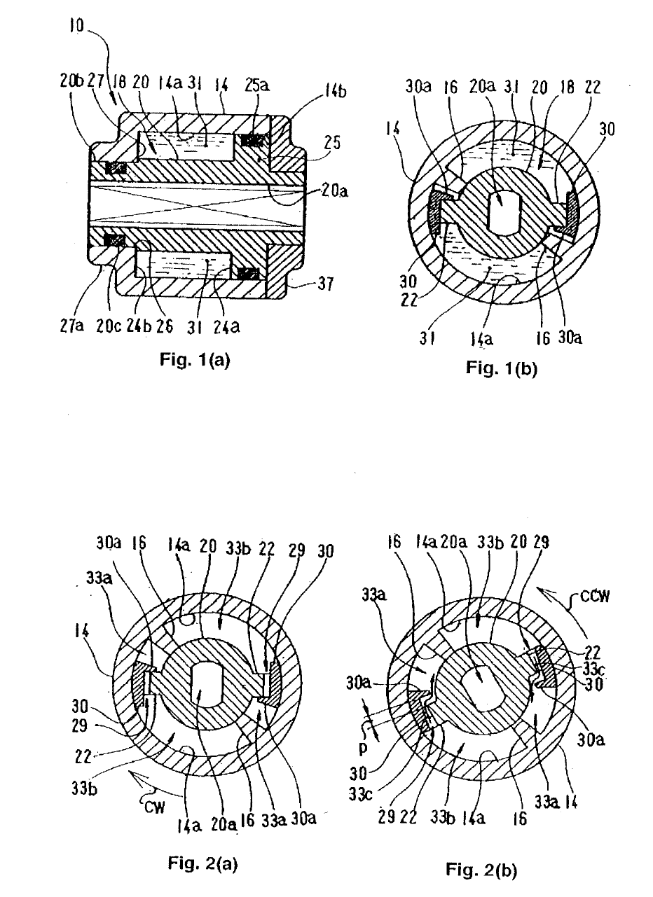

FIG. 1 is a cross-sectional view of a first embodiment of an oil damper device of the present invention: (a) is a cross-section along a rotary shaft of the oil damper device; (b) is a cross-section perpendicular to the rotary shaft, showing the configuration of check valves 30 (which is described later).

Code 10 indicates an oil damper device of a first embodiment. In a case 14, which is a cylindrical member, a partition wall 16 is provided on an inner surface 14a of the case 14 projecting in the radial direction from two positions that are symmetric about an axis. The point of the partition wall 16 is formed to be arc-like and face a predetermined gap between the point and an outer circumferential surface of a rotary shaft 20, which constitutes a rotor 18 as a shaft unit.

Note that a coupling hole 20a having an oval cross-section, which is to be coupled to a hinge shaft (not illustrated), is formed through a center of the rotary shaft 20 of the first embodiment.

At the rotor 18, wings 22 projecting from the rotary shaft 20 toward the inner surface 14a of the case 14 (herein after denoted as “revolving wings”) and check valves 30 are provided respectively symmetric about an axis.

The point end of the revolving wing 20 is formed to be arc-like along the inner surface 14a of the case 14. In the axial direction of the rotary shaft 20, the revolving wings 22 are sandwiched between a first viscous fluid pressure surface 24a and a second viscous fluid pressure surface 24b.

The first viscous fluid pressure surface 24a is an inner surface of a flange portion 25 having a large diameter, which is formed together with the rotary shaft 20, and an O-ring 25a is attached as a sealing member around the outer periphery of the flange portion 25. Then, the flange portion 25 is fitted into an opening having a large diameter 14b, which is formed in the case 14.

The second viscous fluid pressure surface 24b is constituted of a surface 27 which is created when an opening having a small diameter 26 (hereinafter denoted as “through hole”) is formed in the case 14.

As illustrated in FIG. 1, a cylindrical boss 27a is formed in the through hole 26, and a shaft portion 20b of the rotary shaft 20, to which an O-ring 20c is attached, is supported by the inner surface of the boss 27a. Thus, the rotary shaft 20 is supported in a stable manner.

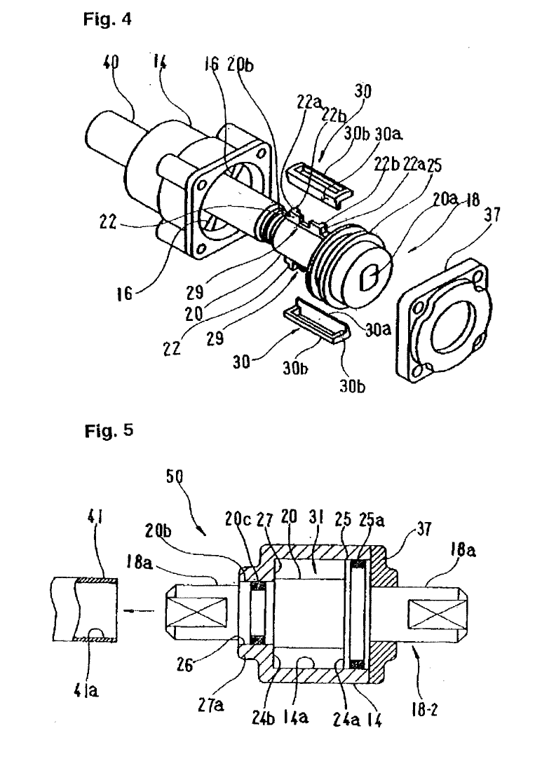

As illustrated in FIG. 4, both axial end surfaces 22a, 22a of each revolving wing 22 are respectively opposite to the first and second viscous fluid pressure surfaces 24a, 24b with a gap.

Each revolving wing 22 has protrusions 22b, 22b on both sides in the axial direction and a notch 29 as an orifice between the protrusions 22b, 22b. The notch 29 has a predetermined length and width in the revolving direction.

Oil 31 which is used as the viscous fluid is filled in a space surrounded by the inner surface of the flange 25 (the first viscous fluid pressure surface 24a), the surface 27 created in the case 14 (the second viscous fluid pressure surface 24b), the inner surface 14a of the case 14, and the rotary shaft 20, and then sealed.

Each of two spaces created by the partition wall 16 inside the case 14 is divided into oil chamber (A) 33a and oil chamber (B) 33b by the revolving wing 22 (see FIG. 2).

Further, a check valve 30 is attached to the revolving wing 22 maintaining a gap, p, from the revolving wing 22 in the rotational direction, and supported so as to move in the gap, p, along the inner surface 14a of the case 14 (see FIG. 2 (b)).

Note that, in this embodiment, the check valve 30 is attached to the revolving wing 22 by a simple prevention of slip-off using a snap-fit to prevent it from slipping off the revolving wing 22 and also to improve the operability in assembly.

The check valve 30 has a valve portion 30a, which entirely covers the notch 29 (orifice) of the revolving wing 22, and a contact portion 30b, which makes contact with the inner surface 14a of the case 14.

Next, an operation of the oil damper device of the present invention is described.

FIG. 2 (a) shows a movement of the check valve 30 in the direction which the oil damping function is at work (in the CW direction in the figure). FIG. 2 (b) shows a movement of the check valve 30 in the direction which the damping function is idle (in the CCW direction in the figure). Both of the figures are cross-sections perpendicular to an axis.

In FIG. 2 (a), when the case 14 is fixed and the rotary shaft 20 is rotated clockwise (in the CW direction), the oil in the oil chamber (A) 33a is pressurized. Therefore, the oil tries to move to the oil chamber (B) 33b.

However, since the valve portion 30a of the check valve 30 is tightly attached to the revolving wing 22 to seal the notch 29 in the revolving wing 22, the oil 31 escapes through a very small gap between the inner surface 14a of the case 14 and the rotary shaft 20, the revolving wing 22, the check valve 30, etc.

Then, the resistance of the oil becomes large, which turns to be like a brake to the oil flow, and the toilet seat/cover closes slowly.

Note that although the oil 31 may escape through the gap between the partition wall 16, 16 and the rotary shaft 20, because the gap is very small, there is resistance to the flow of the oil 31.

In FIG. 2 (b), when the case 14 is fixed and the rotary shaft 20 is rotated counterclockwise (in the CCW direction), the oil in the oil chamber (B) 33b is pressurized. Therefore, the oil tries to move to the oil chamber (A) 33a.

At that time, the check valve 30 moves by the gap, p, due to the oil resistance, the valve portion 30a detaches from the notch 29, and the notch 29 is opened. With this, the gap, p, and the notch 29 between the revolving wing 22 and the check valve 30 become an oil path 33c. When the revolving wing 20 is revolved counterclockwise (in the CCW direction), the oil 31 can move easily from the oil chamber (B) 33b to the chamber (A) 33a. For this reason, the oil resistance is small (or not generated at all), and therefore, the rotary shaft 20 rotates so freely that the toilet seat/cover can be opened with a light force.

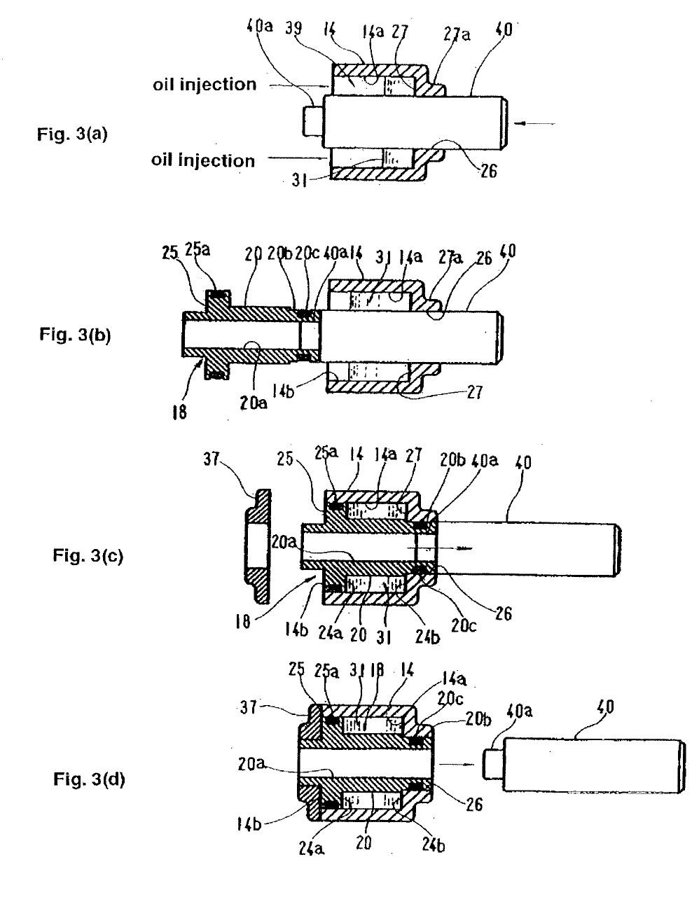

Next, an assembly of an oil damper device 10 of the present invention is described. FIGS. 3 (a) through (d) are schematic cross-sectional views according to the order of steps; the left side in the figures is the top portion of the device.

In FIG. 3 (a), a guide bar 40 which acts as a guide member and has the same diameter as that of the through hole 26, is inserted as a jig through the hole 26 at the boss 27a of the case 14 so that the case 14 has a bottom temporarily. Then, a predetermined amount of oil 31 is injected through the large opening 14b into a space 39 inside the case 14.

In FIG. 3 (b), the O-ring 20c is attached around the outer periphery of the shaft portion 20b of the rotary shaft 20, and the O-ring 25a is attached around the outer periphery of the flange portion 25. The check valve 30 is also attached to the revolving wing 22. The rotary shaft 20 is formed such that the outer end surface of the shaft portion 20b is engaged with the tip end of the guide bar 40 to form a continuous outer circumference (see FIG. 4). Specifically, the tip end (end portion) of the guide bar 40 is formed as a protruded engaging portion 40a which has the cross-section of the same shape as the coupling hole 20a, so that the engaging portion 40a can be concentrically coupled to the coupled hole 20a of the rotary shaft 20.

In FIG. 3 (c), the rotor 18 coupled with the guide bar 40 is slid into the case 14 in which the oil 31 is filled; the oil 31 is sealed between the inner surface 14a of the case 14, which is defined by the first and second viscous fluid pressure surfaces 24a, 24b in the axial direction, and the rotor 18 by both ends of the rotor 18.

In FIG. 3 (d), the guide bar 40 is pulled out from the rotor 18, and the cover 37 is fixed to the case 14 to prevent the rotor 18 from coming off the case 14. Thus, an assembly of the damper device is completed.

The cover 37 is used for engaging the rotor 18 inside the case 14, not for preventing the (oil) the viscous fluid from leaking. Also, the guide bar 40 is used again for another assembly.

The assembling means that uses such a jig for oil injection can be applied to the case 14 that has a though hole 26 of a small diameter on one end and an opening 14b of a large diameter on the other end. Other embodiments of the oil damper device of the present invention are described based on FIGS. 5 through 9. The same members as the above embodiment are given the same codes. The operation of each embodiment is the same as the first embodiment, and the descriptions are omitted.

An oil damper device 50 of a second embodiment, as illustrated in FIG. 5, is configured such that a center shaft 18a of a rotor 18-2 is extended to the right and left sides of the case 14, and the O-ring 20c is attached to the shaft portion 20b of the rotary shaft 20 and the O-ring 25a is attached to the flange portion 25 having a large diameter in the same manner as in the oil damper device 10 of the first embodiment.

At the tip end of the guide bar 40, an engaging portion 41a is recessed to engage with the center shaft 18a. With this, the outer circumference of the core portion can be continuous with the outer circumference of the rotary shaft 20.

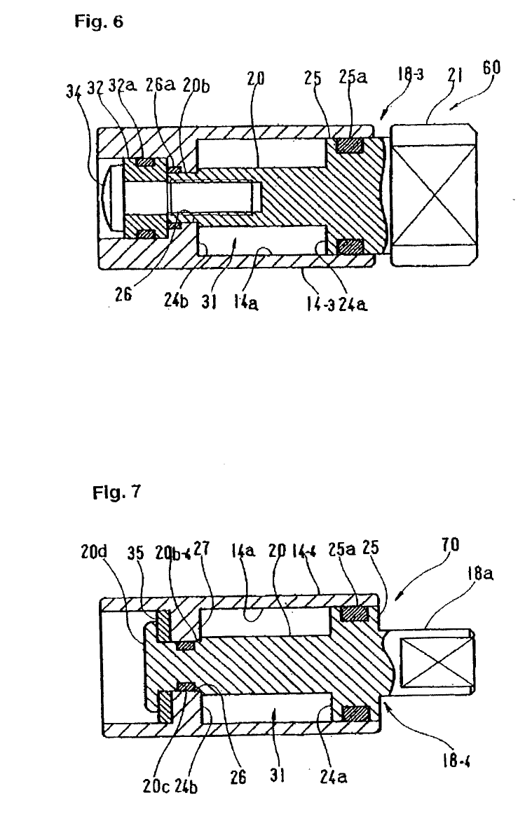

An oil damper device 60 of a third embodiment, as illustrated in FIG. 6, is configured such that the cover 37 is not used, but a screw member 34 such as a bolt is screwed into the rotary shaft 20 via a bearing plate 32 from the direction opposite to the rotor 18-3 inserting direction to prevent the rotor 18-3 from coming outside the case 14-3. Also, the O-ring 25a attached to the flange portion 25, the O-ring 26a attached to the through hole 26, and an O-ring 32a attached to the bearing plate 32 prevent the injected oil (viscous fluid) from leaking.

Note that an adhesive is applied to the screw member 34 to prevent the screw member from loosening.

According to the third embodiment, the cover 37 is eliminated; therefore, an external connection shaft 21 that extends outside the case 14 can be of any size.

In other words, there is no need of making the external connection shaft 21 of the rotary shaft 20 to have a small diameter, as in the third embodiment, so that the through hole formed in the cover 37 can be inserted, or separately forming an external shaft to have a reduced diameter and a cross-section of non-circular, spline or key binding, to be inserted into the cover 34 and fitted into the rotary shaft 20.

According to the configuration of the damper device 60, the external connection shaft 21 which is integrally formed with the rotor member 18-3 can be formed to have the outer diameter equal to or larger than the outer diameter of the case 14-3 or even in any other diameter and shape.

An oil damper device 70 of a fourth embodiment, as illustrated in FIG. 7, is configured such that a resin mold is used for the rotor member 18-4, and in place of the screw member 34 of the third embodiment, an engaging portion 20d is formed at the shaft portion 20b-4 of the rotary shaft 20 by ultrasonic-welding or caulking. With this, the rotor 18-4 is kept from coming off the case 14-4 for sure. Note that, in the fourth embodiment, a bearing plate 35 is interposed between the engaging portion 20d and the opening having a small diameter.

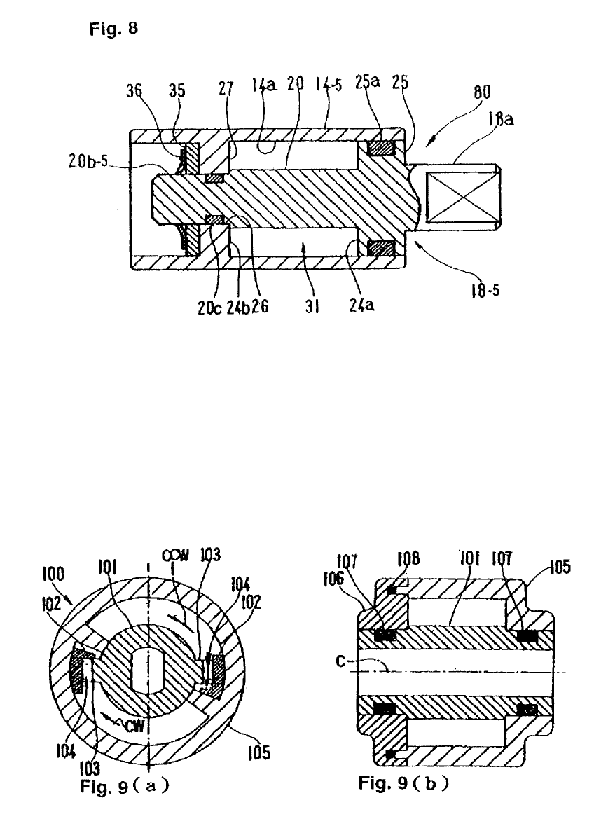

An oil damper device 80 of a fifth embodiment, as illustrated in FIG. 8, is configured such that a snap ring 36 may be provided to the shaft portion 20b-5, which extends outside the surface 37 formed in the case 14-5, to prevent the rotor from moving in the axial direction.

As the snap ring 36 is meshed with the shaft portion 20b-5, a portion of the inner circumference thereof is irreversibly and elastically deformed. In other words, the snap ring 36 is just pushed into the shaft portion 20b-5; thus, the attaching operation is extremely simple and efficient. The snap ring can be applied to the rotor 18-5 composed of a resin mold or metallic product.

Although the embodiments of the present invention have been described above, the present invention is not limited to these embodiments illustrated in the figures, but within the scope of the invention various improvements can be anticipated by modifying details, re-configuring the components, or changing the combinations of the embodiments.

For example, the damper device of the present invention can be applied not only to toilet seats/covers, but also to moving units, such as door closer or trash lids, which are connected by a hinge to move lightly in one direction and move slowly in the other direction. Thus, the present invention can be applied widely.

Also, an O-ring is used as the sealing member; however, other than this, sealing such as rubber packing, Y-packing, V-packing, etc. may be used.

As understood from the above descriptions, according to this invention, the damper device that uses viscous fluid of the present invention comprises a cylindrical member having a cylindrical inner surface, a shaft arranged inside the cylindrical member to face the inner surface in the radial direction, a space created by an outer circumferential surface of the shaft and the inner surface of the cylindrical member for a viscous fluid to be injected, a partition wall formed at the cylindrical member to project into the space, wings provided on the shaft for pressurizing the viscous fluid, and check valves; wherein the shaft has a flange portion with a diameter larger than that of a shaft portion of the shaft and also has a first viscous fluid pressure surface for the viscous fluid; the cylindrical member has a second viscous fluid pressure surface for the viscous fluid, a small opening with the same diameter as that of the shaft portion, and a large opening with the same diameter as that of the flange portion; a first sealing member is provided between said shaft portion and said small opening and a second sealing member is provided between the flange portion and the large opening to seal the viscous fluid. Therefore, the number of sealing positions can be reduced, improving reliability toward the oil leak prevention.

Further, according to this invention, in the damper device that uses viscous fluid of the present invention, O-rings are used for the first and second sealing members to seal the viscous fluid. Thus, an assembling operation is easy, increasing reliability toward oil leak prevention.

According to the method of manufacturing of a damper device that uses viscous fluid, disclosed in this invention, a guide member is fitted in the small opening and a predetermined amount of viscous fluid is injected into a space that is created temporarily by the guide member and the inner surface of the cylindrical member, and then the guide member is replaced with the shaft. Since the oil can be injected through the opening having a large diameter, the viscous fluid with high viscosity can be easily injected. This facilitates setting and improvement of damper properties. Furthermore, since the injection area is wide, the operation time can be shortened and a viscous fluid loss due to overflow can be reduced. Thus, the assembling operation becomes simple.

According to the method of manufacturing of a damper device that uses viscous fluid, disclosed in this invention, the guide member has the same diameter as that of the shaft portion of the shaft and is capable of entering the small opening, and an engaging portion that can be engaged with the shaft portion is provided at the end portion of the guide member; the shaft portion is engaged with the engaging portion provided at the end portion of the guide member, and then the guide member is replaced with the shaft. Therefore, the viscous fluid can be easily injected, reducing the operation time and cost.

While the foregoing description and drawings represent the present invention, it will be obvious to those skilled in the art that various changes may be made therein without departing from the true spirit and scope of the present invention.

What is claimed is:

1. A damper device that uses viscous fluid comprising:
a cylindrical member having a cylindrical inner surface;
a shaft being arranged inside said cylindrical member to face said inner surface in the radial direction;
an outer circumferential surface of said shaft and said inner surface of said cylindrical member forming a space for a viscous fluid to be injected;
a partition wall being formed at said cylindrical member to project toward said space;
wings being provided on said shaft for pressurizing said viscous fluid;
check valves associated with said wings;
said shaft having a flange portion having a diameter larger than that of a shaft portion of said shaft and also having a first viscous fluid pressure surface for said viscous fluid;
said cylindrical member having a second viscous fluid pressure surface for said viscous fluid, a small opening having the same diameter as that of said shaft portion and a large opening having the same diameter as that of said flange portion; and
a first sealing member being provided between said shaft portion and said small opening and a second sealing member being provided between said flange portion and said large opening to seal said viscous fluid.

2. The damper device as set forth in claim 1, wherein O-rings are used for said first and second sealing members to seal said viscous fluid.

3. A method of manufacturing the damper device that uses viscous fluid as in claim 1, comprising the steps of:
fitting a guide member in said small opening;
injecting a predetermined amount of said viscous fluid into a space that is created temporarily by said guide member and said inner surface of said cylindrical member; and
replacing said guide member with said shaft.

4. The method of manufacturing the damper device that uses viscous fluid as in claim 3, wherein said guide member has the same diameter as that of said shaft portion of said shaft and is capable of entering said small opening, and an engaging portion that can be engaged with said shaft portion being provided at an end portion of said guide member; said shaft portion being engaged with said engaging portion provided at the end portion of said guide member, and then said guide member is replaced with said shaft.
